(19) United States
(12) Patent Application Publication
(10) Pub. No.: US 2015/0127886 A1
(43) Pub. Date: May 7, 2015

(54) MEMORY SYSTEM AND METHOD

(71) Applicant: KABUSHIKI KAISHA TOSHIBA, Minato-ku (JP)

(72) Inventor: Shinichi KANNO, Ota-ku (JP)

(73) Assignee: KABUSHIKI KAISHA TOSHIBA, Minato-ku (JP)

(21) Appl. No.: 14/206,605

(22) Filed: Mar. 12, 2014

(30) Foreign Application Priority Data
Nov. 1, 2013 (JP) 2013-228593

(51) Int. Cl. G06F 12/02

(52) U.S. Cl. CPC G06F 12/0246; G06F 2212/7207
USPC 711/103

(57) ABSTRACT

According to an embodiment, a memory system is provided with a nonvolatile memory, which is configured by a plurality of memory cells, and a controller. The memory is provided with a plurality of first blocks and a plurality of second blocks. The plurality of first blocks are provided with a third block in which no valid data is stored. The plurality of second blocks are provided with a fourth block in which no valid data is stored. When a host makes a request for writing data, the controller writes the data in the third block in a case where the number of the third blocks is larger than a first threshold. In a case where the number of the third blocks is smaller than the first threshold, the controller writes the data in the fourth block.

### CROSS-REFERENCE TO RELATED APPLICATIONS

This application is based upon and claims the benefit of priority from Japanese Patent Application No. 2013-228593, filed on Nov. 11, 2013; the entire contents of which are incorporated herein by reference.

### FIELD

Embodiments described herein relate generally to a memory system and a method.

### BACKGROUND

As a technology of increasing the capacity of a NAND flash memory, there is a multi-level cell (MLC) technology. In recent years, an MLC flash memory is often written in a pseudo-SLC (Single-Level Cell) method in order to increase a writing speed or reliability. In the SLC method (hereinafter, referred to as an SLC mode), one bit data is stored in one cell which is a unit of storing. On the other hand, in the MLC method (hereinafter, referred to as an MLC mode), N bits data (N>1) can be stored in one cell. Therefore, for example, a 2-bit/cell flash memory can express 4 values by one cell, and a 3-bit/cell flash memory can express 8 values by one cell.

A flash memory which stores a relatively large amount of information in the same physical storage area (cell) can be increased in capacity per area or volume compared to a flash memory which stores a relatively small amount of information in the same physical storage area (cell). In addition, there is a merit on suppressing a cost per capacity. On the other hand, the flash memory which stores a relatively small amount of information in the same storage area can reduce a writing access time compared to the flash memory which stores a relatively large amount of information in the same storage area. In addition, there is a merit on increasing reliability.

### BRIEF DESCRIPTION OF THE DRAWINGS

FIG. 1 is a diagram illustrating an outline of an operation of a memory system according to a first embodiment;

FIG. 2 is a diagram illustrating an outline of an operation of the memory system according to the first embodiment;

FIG. 3 is a diagram illustrating an outline of an operation of the memory system according to the first embodiment;

FIG. 4 is a schematic diagram illustrating an example of an information processing apparatus in which the memory system according to the first embodiment can be mounted;

FIG. 5 is a diagram illustrating a configuration of the memory system according to the first embodiment;

FIG. 6 is a flowchart illustrating an operation of the memory system according to the first embodiment when a host device makes a request for writing data;

FIG. 7 is a flowchart for describing an allocation process;

FIG. 8 is a flowchart for describing a first transcription process;

FIG. 9 is a flowchart for describing a second transcription process;

FIG. 10 is a diagram illustrating a change in writing performance in a case where a host device makes a request for writing data continuously;

FIG. 11 is a diagram illustrating a memory configuration of a buffer memory unit according to a second embodiment; and

FIG. 12 is a flowchart illustrating an operation of the memory system according to the second embodiment when a host device makes a request for writing data.

### DETAILED DESCRIPTION

In general, according to one embodiment, a memory system is provided with a nonvolatile memory, which is configured by a plurality of memory cells, and a controller. The nonvolatile memory is configured to include a plurality of first blocks in which data is written in a first mode and a plurality of second blocks in which data is written in the first mode or a second mode. The second mode is a mode such that each memory cell has a larger storage capacity than that of the first mode. The plurality of first blocks include a third block in which no valid data is stored. The plurality of second blocks include a fourth block in which no valid data stored. The controller writes data requested for writing from a host in the third block when the number of the third blocks is larger than a first threshold. The controller writes data requested for writing from the host in the fourth block when the number of the third blocks is smaller than the first threshold.

Exemplary embodiments of the memory system and the method will be explained below in detail with reference to the accompanying drawings. The present invention is not limited to the following embodiments.

### First Embodiment

A NAND flash memory used in a first embodiment, for example, is a flash memory 112 of which the operation mode for writing data can be changed. As the operation mode, a first mode and a second mode are used. In the first mode, the amount of information to be written in the same storage area is smaller than that in the second mode (that is, the amount of information to be written in the same storage area in the second mode is larger than that in the first mode). For example, the second mode is a mode in which the number of bits to be written in one cell is larger than that in the first mode. Further, as a specific example, the first mode is an SLC mode or an MLC mode. The second mode is the MLC mode in which the number of bits to be written in one cell is larger than that in the first mode. In the following, the description will be made on the assumption that the first mode is the SLC mode and the second mode is the MLC mode. In this case, the MLC mode is not limited to one mode, but may include a plurality of modes. In other words, a 4-level mode, an 8-level mode, or further higher-level modes may be alternatively used.

Including the flash memory 112, the storage area of a NAND flash memory chip is configured to include a plurality of blocks. A block is a predetermined unit of storage area, and an erasure unit of data. Therefore, when new data is written in a certain block, it is necessary to collectively erase data which has been stored in the block.

Each block is configured to include a plurality of pages. The writing and reading of data are performed in a unit of page. There is a rule in the order of pages to write the data. Therefore, after the data is erased in a unit of block, the block is necessarily written with data in a specific page order. In other words, after the data is written in a block, overwriting only on a specific page cannot be performed without erasing the data in the block; even after the data is erased from the block, the data cannot be written in a random page in the block.

In addition, the operation mode of each NAND flash memory can be independently set for every block. In this case, there is a need to be set the pages in one block with the same operation mode. Therefore, the operation mode cannot be switched in a unit of page. In other words, after a block is once written with data in its pages, the operation mode of the block cannot be switched until the data in the block is collectively erased.

The respective operation modes are different in size of data to be written in a block. In other words, the size of a block (hereinafter, referred to as a block size) is changed according to the operation mode. Specifically, the respective pages have the same page size, but the number of pages is changed. For example, in the case of a 2-bit/cell type of flash memory, the number of pages and the block size of an SLC block of a 2-level mode become ½ compared to an MLC block of the 4-level mode.

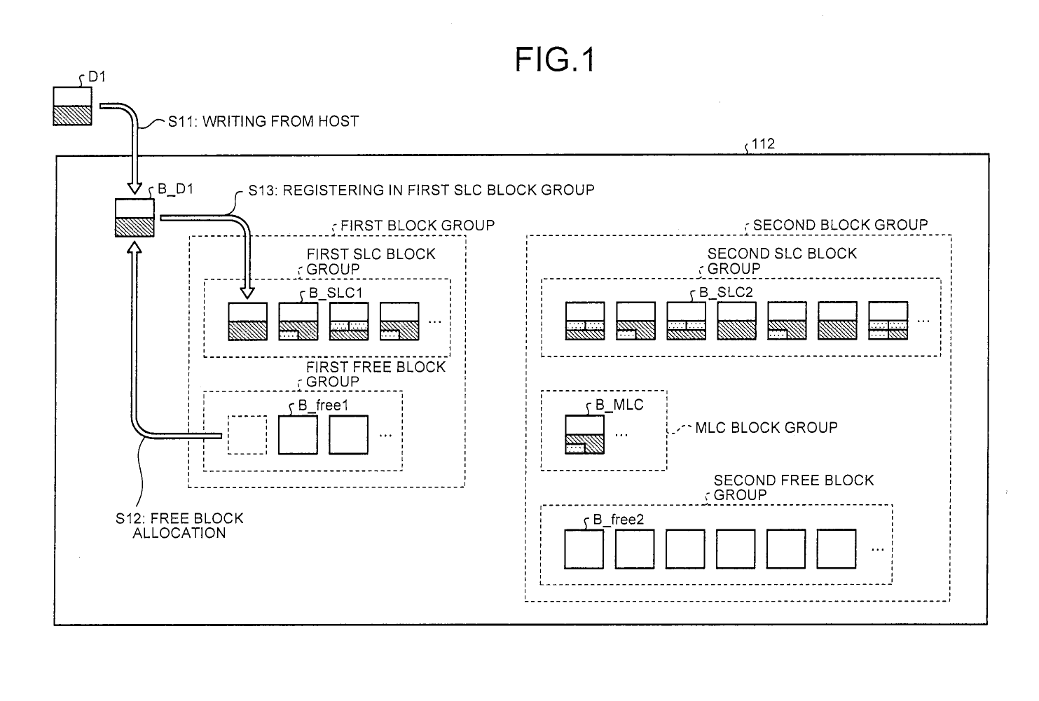

In the first embodiment, as illustrated in FIGS. 1 to 3, the flash memory 112 is provided with a first block group which includes blocks set to be used only in the first mode and a second block group which includes blocks available in either the first mode or the second mode by switching. The number of blocks included in the first block group is fixed. The first block group is provided with first free blocks B_free1 in which no valid data is stored and first SLC blocks B_SLC1 in which valid data written in the first mode is stored. The second block group is provided with second free blocks B_free2 in which no valid data is stored, second SLC blocks B_SLC2 in which valid data written in the first mode is stored, and MLC blocks B_MLC in which valid data written in the second mode is stored.

In addition, the respective blocks are classified into groups for management. The first free blocks B_free1 are managed as a first free block group, and the first SLC blocks B_SLC1 are managed as a first SLC block group. The second free blocks B_free2 are managed as a second free block group, the second SLC blocks B_SLC2 are managed as a second SLC block group, and the MLC blocks B_MLC are managed as an MLC block group.

In the first embodiment, as illustrated in FIG. 1, when a host device makes a request for writing data D1 (S11), the data D1 is written in the SLC mode in the first free block B_free1 which is allocated as a block for writing new data (S12). A new data writing block B_D1 in which the data D1 is written is registered in the first SLC block group (S13). As a result, the number of the first free blocks B_free1 which are managed in the first free block group is decreased by 1, and instead the number of the first SLC blocks B_SLC1 managed in the first SLC block group is increased by 1. The data writing on the first free blocks B_free1 in the SLC mode is performed until the number of the first free blocks B_free1 managed in the first free block group becomes smaller than a preset threshold Ta.

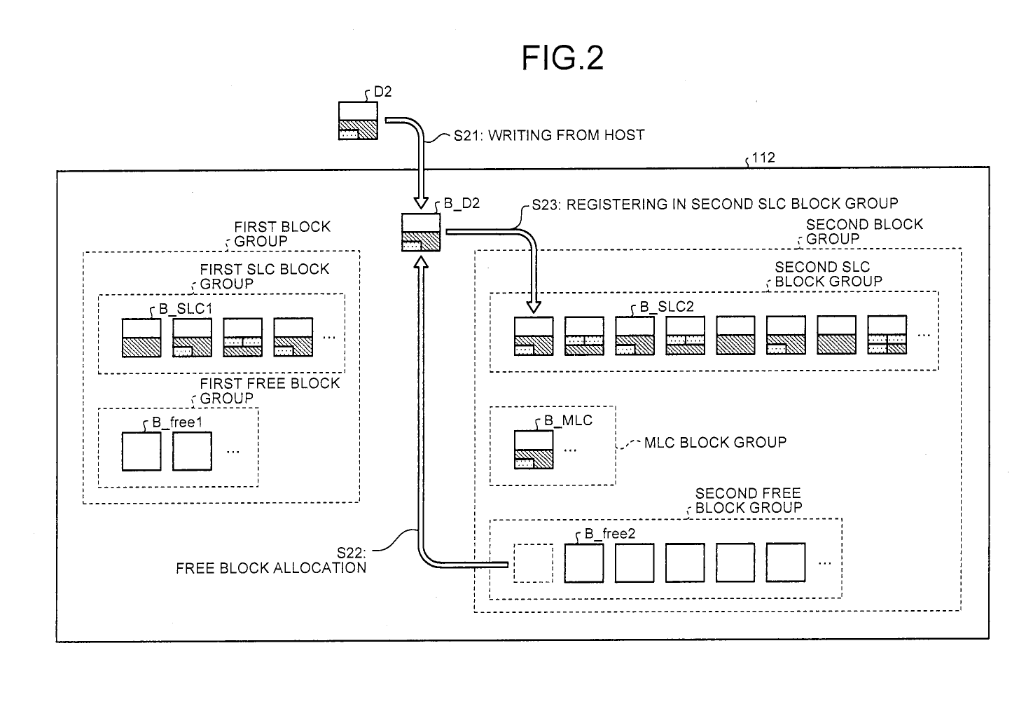

In a case where the number of the first free blocks B_free1 managed in the first free block group is smaller than the threshold Ta, as illustrated in FIG. 2, when the host device makes a request for writing data D2 (S21), the data D2 is written in the SLC mode in the second free block B_free2 which is allocated as the block for writing new data (S22). A new data writing block B_D2 in which the data D2 is written is registered in the second SLC block group (S23). The number of the second free blocks B_free2 managed in the second free block group is decreased by 1, and instead the number of the second SLC blocks B_SLC2 managed in the second SLC block group is increased by 1. The data writing on the second free blocks B_free2 in the SLC mode is performed in a case where the number of the second free blocks B_free2 managed in the second free block group is larger than a preset threshold Tb and the number of the second SLC blocks B_SLC2 managed in the second SLC block group is smaller than a preset threshold Tc.

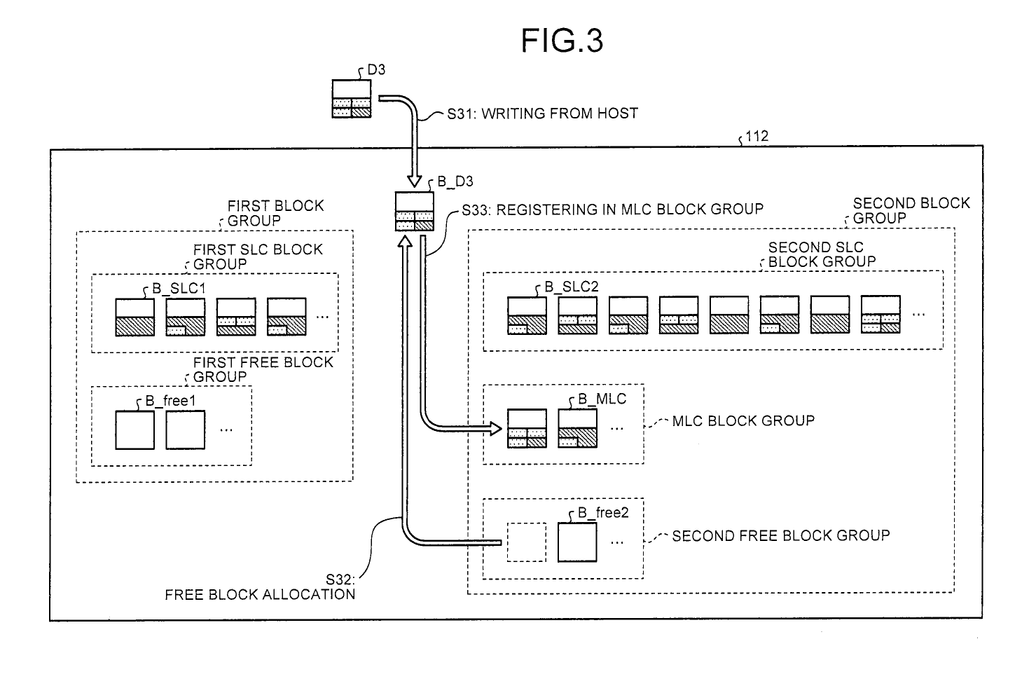

In a case where the number of the second free blocks B_free2 managed in the second free block group is smaller than the preset threshold Tb or the number of the second SLC blocks B_SLC2 managed in the second SLC block group is larger than the preset threshold Tc, as illustrated in FIG. 3, when the host device makes a request for writing data D3 (S31), the data D3 is written in the MLC mode in the second free block B_free2 which is allocated as the block for writing new data (S32). A new data writing block B_MLC in which the data D3 is written is registered in the MLC block group (S33). The number of the second free blocks B_free2 managed in the second free block group is decreased by 1, and instead the number of the MLC blocks B_MLC managed in the MLC block group is increased by 1.

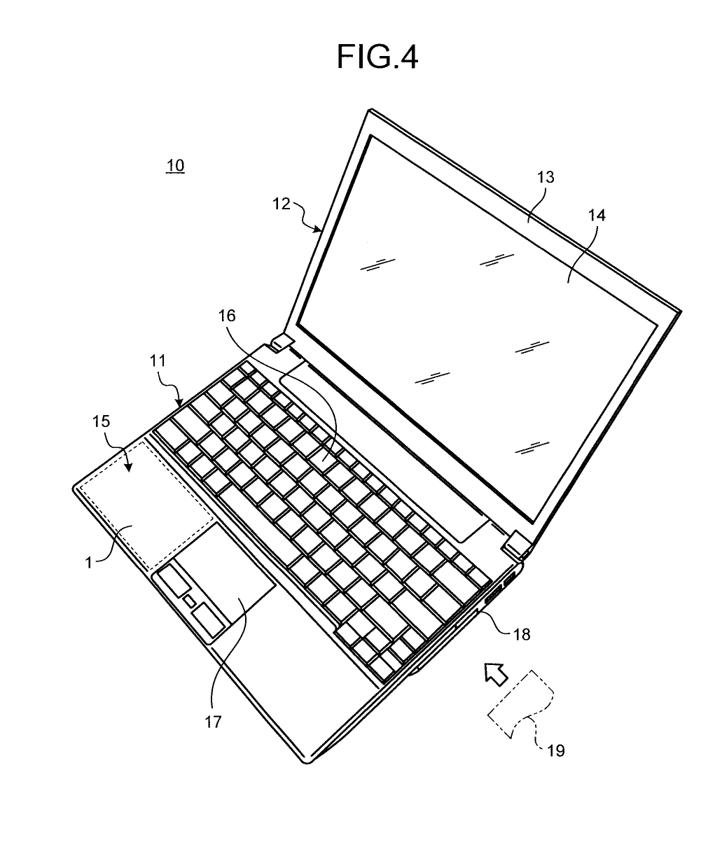

FIG. 4 is a schematic diagram illustrating an example of an information processing apparatus in which the memory system according to the first embodiment can be mounted. A personal computer 10 illustrated in FIG. 4 is mainly configured to include a main body 11 and a display unit 12. The main body 11, for example, is provided with a housing 15, a keyboard 16, a touch pad 17 which is a point device, an external interface 18 such as a card slot for a detachable memory card 19 and a universal serial bus (USB), a main circuit board, and a memory system 1 which is a solid state drive (SSD).

In the main circuit board, main components such as a central processing unit (CPU), a read only memory (ROM), a random access memory (RAM), a north bridge, and a south bridge are mounted. Besides these components, the main body 11 may be provided with an optical disk drive (ODD) unit, various kinds of external interfaces, and the like.

The display unit 12 is provided with a display housing 13 and a display 14 which is contained in the display housing 13. Further, a so-called notebook personal computer is given as an example in FIG. 4, but the invention is not limited thereto. In other words, the memory system according to the first embodiment can be applied to all the computers in which the flash memory can be mounted or equipped as a storage unit.

In FIG. 4, the memory system 1 is a storage device which uses a rewritable nonvolatile memory as a recoding medium. The memory system 1 may be built in the personal computer 10, or may be attached from the outside to the personal computer 10 through the external interface 18. Hereinafter, the memory system 1 according to the first embodiment will be described in detail with reference to the drawings.

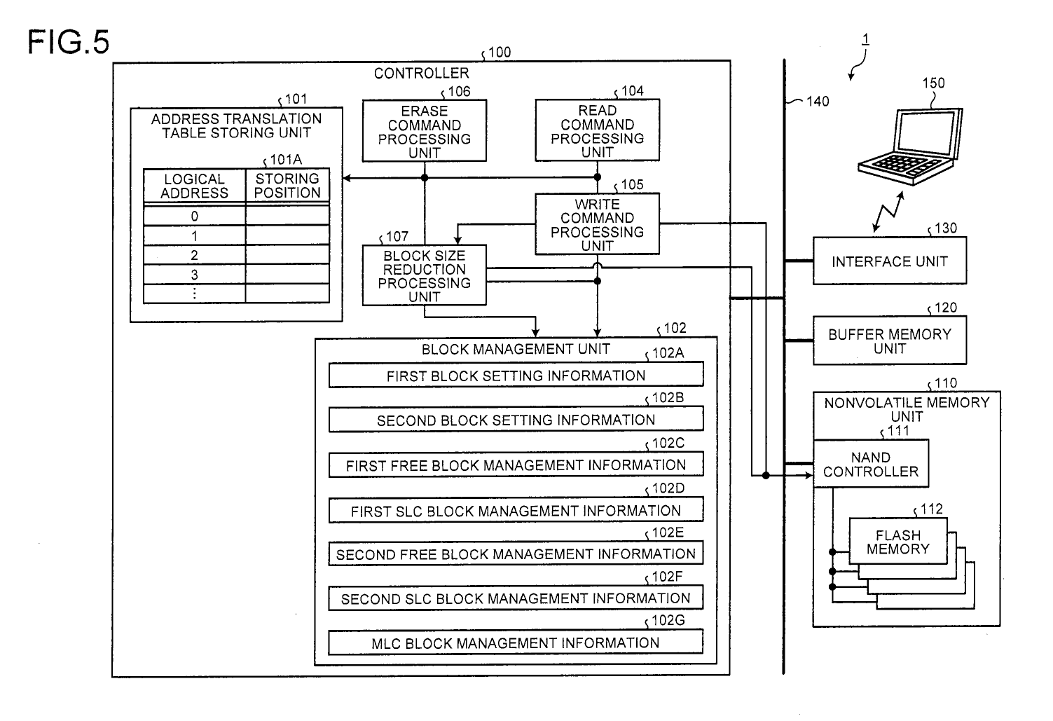

As illustrated in FIG. 5, the memory system 1 is provided with a controller 100, a nonvolatile memory unit 110, a buffer memory unit 120, and an interface unit 130 when roughly classified. The respective components 100 to 130 can be connected to one another through a signal line 140 such as a common bus or a dedicated line. In addition, the signal line 140 can also be connected to a host device 150 such as a personal computer or a workstation, which makes a request for writing/reading data with respect to the nonvolatile memory unit 110.

The interface unit 130 communicates with the host device 150 through the signal line 140. The interface unit 130 receives a command such as read, write, flash, and data erase from the host device 150, and informs the controller 100 of the command reception. In addition, the interface unit 130 transmits or receives data with respect to the host device 150 according to an instruction from the controller 100.

As the buffer memory unit 120, a memory which has a high random accessibility and a high speed is used, for example, an SRAM, a DRAM, or the like. The buffer memory unit 120 is not necessarily a nonvolatile memory. The buffer memory unit 120 temporarily stores data which is transmitted or received between the interface unit 130 and the host device 150, data which is read from the nonvolatile memory unit 110, or data which is written in the nonvolatile memory unit 110. In addition, the buffer memory unit 120 may store information for various kinds of management besides the data.

The nonvolatile memory unit 110 is configured to include one or more flash memories 112 and a NAND controller 111. The flash memory 112, for example, is a NAND flash memory. One flash memory 112 may be configured in one chip. In general, a total storage capacity of the nonvolatile memory unit 110 is necessarily larger than an expressed capacity (a maximum capacity provided to the host device). The nonvolatile memory unit 110 can be mounted with a plurality of flash memories 112 according to a total storage capacity. In addition, the NAND controller 111 may be configured to transmit data in parallel to the plurality of flash memories 112. This is effectively realized, for example, in a case where one flash memory 112 does not satisfy data transfer performance required as an SSD.

The description will be returned to FIG. 5. The controller 100 has functions of managing user data or controlling the respective components. The controller 100 may be configured as a SoC (System on a Chip) in which these functions are assembled as circuits. In addition, the controller 100 may be realized by executing software on a general-purpose hardware processor to embody these functions.

As function blocks, the controller 100 is provided with an address translation table storing unit 101, a block management unit 102, a read command processing unit 104, a write command processing unit 105, an erase command processing unit 106, and a block size reduction processing unit 107.

The address translation table storing unit 101 stores an address translation table 101A which has mapping between a logical address indicated from the host device 150 and a storing position (a physical address) of data in the memory system 1. When the host device 150 makes a request for writing or erasing of data at a logical address or the transcription of the data is performed in the memory system 1, the mapping of the logical address in the address translation table 101A is updated. As a result, the data at a new storing position becomes the valid data, and the data at the old storing position becomes invalid data. A unit of mapping data in the address translation table 101A, for example, is smaller than a block. The unit of mapping data in the address translation table 101A, for example, may be a page size.

The block management unit 102 manages the block groups. The respective blocks belong to any one of the first block group and the second block group. Which one of the first block group and the second block group the respective blocks belong to is set in advance and fixed. The respective blocks belonging to the first block group are registered in first block setting information 102A. The respective blocks belonging to the second block group are registered in second block setting information 102B. Among the plurality of blocks belonging to the first block group, the block management unit 102 registers blocks (the first free block), in which no valid data is stored, in the first free block group, and blocks (the first SLC block), in which the data written in the SLC mode is stored, in the first SLC block group respectively. In addition, among the plurality of blocks belonging to the second block group, the block management unit 102 registers blocks (the second free block), in which no valid data is stored, in the second free block group, blocks (the second SLC block), in which the data written in the SLC mode is stored, in the second SLC block group, and blocks (the MLC block) in which the data written in the MLC mode is stored, in the MLC block group respectively. The block management unit 102 has information (for example, the physical address) of the blocks belonging to the respective block groups and the number of blocks, as management information of the respective block groups. Specifically, the first free block is registered in first free block management information 102C, the first SLC block is registered in first SLC block management information 102D, the second free block is registered in second free block management information 102E, the second SLC block is registered in second SLC block management information 102F, and the MLC block is registered in MLC block management information 102G respectively.

When informed of the reception of a read command from the interface unit 130, the read command processing unit 104 retrieves a storing position in the nonvolatile memory unit 110 corresponding to a logical address indicated by the read command from the address translation table 101A, and reads the date stored at the storing position and sends it out to the buffer memory unit 120. Therefore, data within a range indicated by the read command is temporarily stored in the buffer memory unit 120. Thereafter, the read command processing unit 104 makes a control on the interface unit 130 such that the data temporarily stored in the buffer memory unit 120 is transmitted to the host device 150.

When informed of the reception of a write command from the interface unit 130, the write command processing unit 105 secures an empty area on the buffer memory unit 120, and makes a control on the interface unit 130 such that data is received from the host device 150. Then, when a sufficient amount of data is accumulated in the buffer memory unit 120, the data in the buffer memory unit 120 is written in the block for writing new data. Thereafter, the write command processing unit 105 registers the storing position corresponding to the logical address of the written data in the address translation table 101A to update the mapping. Further, the write command processing unit 105 acquires the first free block or the second free block as the block for writing new data from the block management unit 102, and performs writing on the block for writing new data.

When informed of the reception of an erase command (for example, a trim command) from the interface unit 130, the erase command processing unit 106 updates the mapping defined in the address translation table 101A to invalidate data at the storing position corresponding to the indicated logical address.

The block size reduction processing unit 107 selects one or more available blocks (hereinafter, referred to as a transcription source block) from the available blocks for storing the valid data, and transcribes the valid data in the selected transcription source block to the free block.

The transcription start timing of the block size reduction processing unit 107 is as follows. That is, as a result of that the write command processing unit 105 acquires the first free block as the block for writing new data from the block management unit 102, in a case where the number of remaining first free blocks is lower than a threshold Td, the block size reduction processing unit 107 can start the transcription (a first transcription process). Further, the threshold Td is a preset value larger than the threshold Ta. In addition, the block size reduction processing unit 107 monitors whether the interface unit 130 is under communication with the host device 150 or not, and measures an elapsed time since the interface unit 130 enters a non-communication state. Then, when the elapsed time after the non-communication state is larger than a predetermined time, the block size reduction processing unit 107 starts the transcription (a second transcription process).

As a result of the transcription of the valid data, the block size reduction processing unit 107 collects a transcription source block which becomes a free block, that is, a transcription source block of which the valid data size becomes ‘0’, as a new free block. The mapping of the transcribed data is updated by registering the storing position corresponding to the logical address of the transcription destination in the address translation table 101A. Further, when a block is registered as a free block, the invalid data in the block may be erased. Alternatively, the invalid data may be left unerased when the block is registered as a free block, but erased during a time period after the block is allocated as the available block in the next writing and immediately before the first page of the block is written.

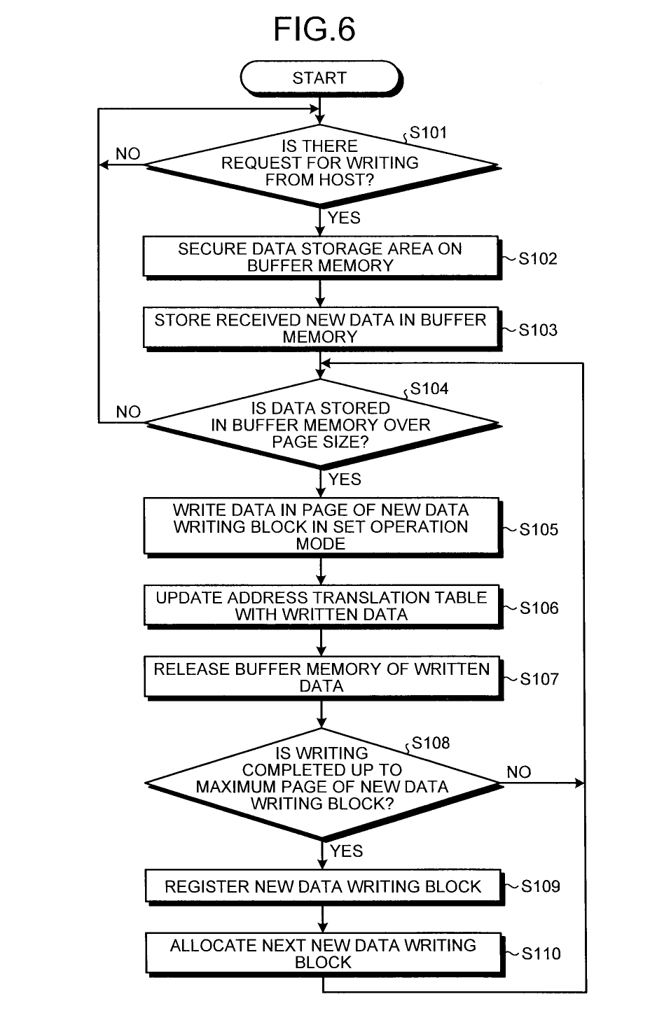

FIG. 6 is a flowchart illustrating an operation when the host device 150 makes a request for writing data. Further, in the operation illustrated in FIG. 6, it is assumed that a new data writing block has been allocated as an initial state.

The write command processing unit 105, first, waits for the input of a write command for new data from the host device 150 to the interface unit 130 (No in S101). When the write command is received (Yes in S101), the write command processing unit 105 secures a data storage area in the buffer memory unit 120 (S102), and subsequently stores the new data transmitted from the host device 150 in the data storage area which is secured in the buffer memory unit 120 (S103).

Next, the write command processing unit 105 checks the data size of the unwritten new data which is stored in the buffer memory unit 120 (S104). When the data size is smaller than the page size (No in S104), the procedure returns to S101. On the other hand, when the data size is equal to or larger than the page size (Yes in S104), the write command processing unit 105 selects data as much as the page size from the unwritten data in the buffer memory unit 120. Then, the write command processing unit 105 writes the selected data in the page of the new data writing block, which has been allocated in the nonvolatile memory unit 110, in the operation mode set in an allocation process of S110 (S105).

Further, in a case where the new data writing block is registered in the first SLC block group or the second SLC block group in the allocation process of S110, the SLC mode is set as the operation mode. In a case where the new data writing block is registered in the MLC block group in the allocation process of S110, the MLC mode is set as the operation mode. The allocation process of S110 will be described in detail below.

Subsequently to the process of S105, the write command processing unit 105 registers the logical address and the storing position (the physical address) of the written data in the address translation table 101A (S106) to update the mapping. Then, the write command processing unit 105 releases the area stored with the written data in the buffer memory unit 120 (S107).

Next, the write command processing unit 105 determines whether there is a page having no written data, that is, an unwritten page in the new data writing block (S108). In a case where there is an unwritten page in the new data writing block (No in S108), the write command processing unit 105 performs the process of S104 again.

On the other hand, in a case where there is no unwritten page (Yes in S108), that is, when the data writing is completed up to a last page in the new data writing block, the write command processing unit 105 performs a registration process of registering the new data writing block in the first SLC block management information 102D, the second SLC block management information 102F, or the MLC block management information 102G (S109). Herein, in a case where the new data writing block belongs to the first block group, the write command processing unit 105 registers the new data writing block in the first SLC block management information 102D. In a case where the new data writing block belongs to the second block group and the operation mode is set to the SLC mode, the write command processing unit 105 registers the new data writing block in the second SLC block management information 102F. In a case where the new data writing block belongs to the second block group and the operation mode is set to the MLC mode, the write command processing unit 105 registers the new data writing block in the MLC block management information 102G.

Next, the write command processing unit 105 performs the allocation process for the next new data writing block (S110). After the process of S110, the write command processing unit 105 performs the process of S101 again.

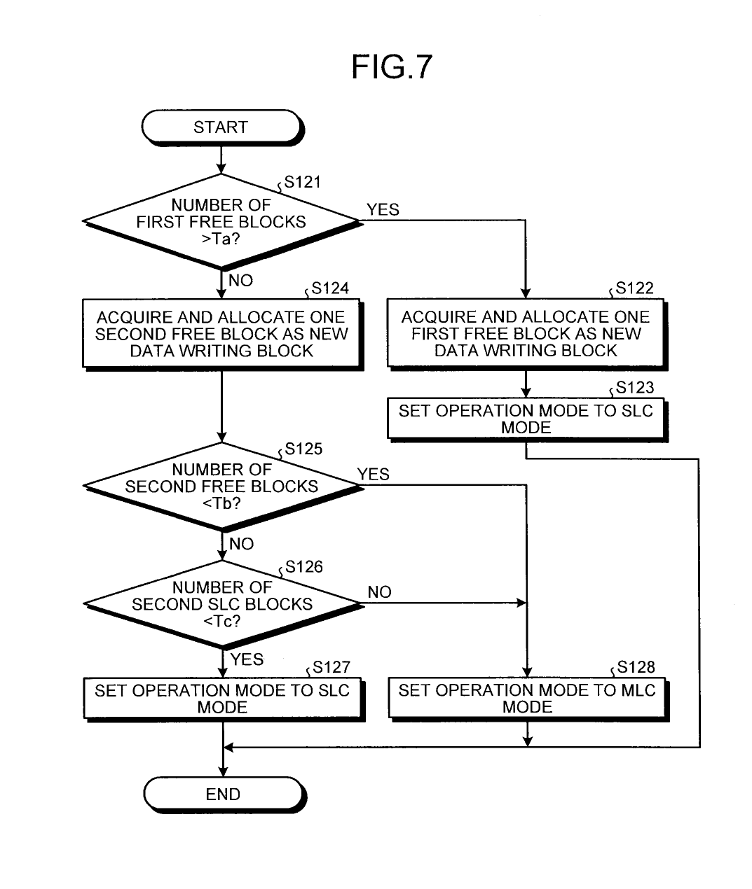

FIG. 7 is a flowchart for describing the allocation process of S110.

First, the write command processing unit 105 refers to the first free block management information 102C to determine whether the number of the first free blocks is larger than the threshold Ta (S121). In a case where the number of the first free blocks is larger than the threshold Ta (Yes in S121), the write command processing unit 105 acquires one of the first free blocks in the first free block management information 102C, and allocates the first free block as the next new data writing block (S122). Then, the write command processing unit 105 sets the operation mode to the SLC mode (S123), and ends the allocation process.

In a case where the number of the first free blocks is smaller than the threshold Ta (No in S121), the write command processing unit 105 acquires one of the second free blocks in the second free block management information 102E, and allocates the second free block as the next new data writing block (S124). Then, the write command processing unit 105 refers to the second free block management information 102E to determine whether the number of the second free blocks is smaller than the threshold Tb (S125). In a case where the number of the second free blocks is larger than the threshold Tb (No in S125), the write command processing unit 105 refers to the second SLC block group management information 102F to determine whether the number of the second SLC blocks is smaller than the threshold Tc (S126). In a case where the number of the second SLC blocks is smaller than the threshold Tc (Yes in S126), the write command processing unit 105 sets the operation mode to the SLC mode (S127), and ends the allocation process. In a case where the number of the second free blocks is smaller than the threshold Tb (Yes in S125) or the number of the second SLC blocks is larger than the threshold Tc (No in S126), the write command processing unit 105 sets the operation mode to the MLC mode (S128), and ends the allocation process.

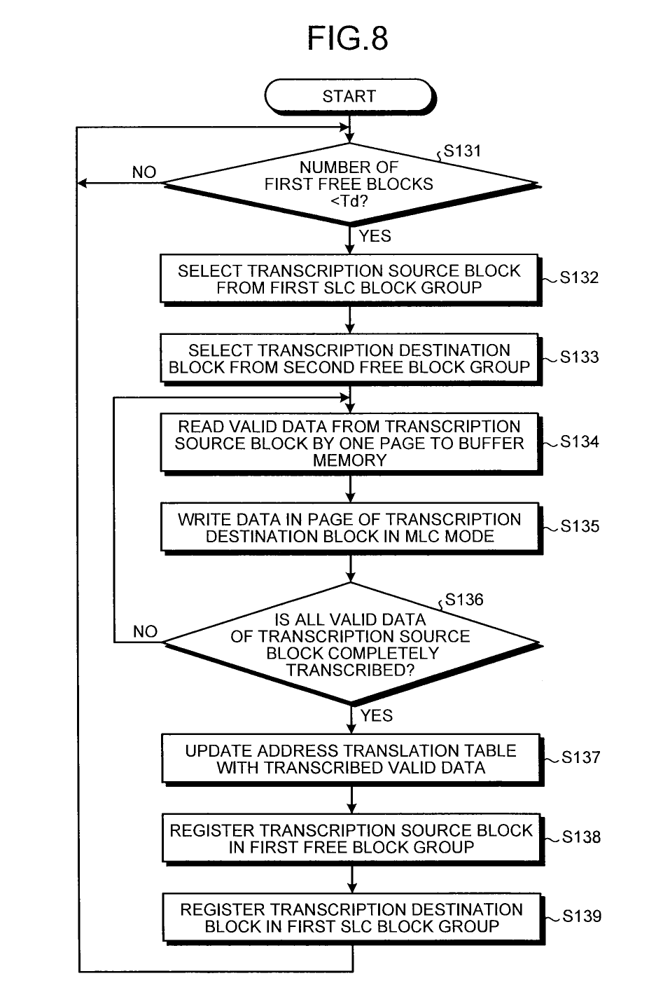

FIG. 8 is a flowchart for describing the first transcription process.

The block size reduction processing unit 107 periodically refers to the first free block management information 102C to determine whether the number of the first free blocks is smaller than the threshold Td (S131). In a case where the number of the first free blocks is larger than the threshold Td (No in S131), the block size reduction processing unit 107 performs the process of S131 again. In a case where the number of the first free blocks is smaller than the threshold Td (Yes in S131), the block size reduction processing unit 107 selects a transcription source block from the first SLC block group (S132).

The way of selecting the transcription source block is arbitrary. For example, the block size reduction processing unit 107 selects the first SLC block, of which the valid data size is smallest, as the transcription source block. In addition, the block size reduction processing unit 107 selects the earliest-written first SLC block as the transcription source block. In addition, the block size reduction processing unit 107 may select a plurality of transcription source blocks in the process of S132.

Next, the block size reduction processing unit 107 selects a transcription destination block from the second free block group (S133). In a case where a plurality of transcription source blocks are selected in the process of S132, the transcription destination blocks are selected as many as a total amount of the valid groups stored in the plurality of transcription source blocks.

Next, the block size reduction processing unit 107 secures the data storage area as much as at least one page on the buffer memory unit 120, and subsequently reads the valid data as much as one page stored in the selected M transcription source blocks and sends out the valid data to the data storage area secured in the buffer memory unit 120 (S134). Then, the block size reduction processing unit 107 writes the valid data, which is read and sent out onto the buffer memory unit 120, in a page of a free block selected as the transcription destination block in the MLC mode (S135).

Next, the block size reduction processing unit 107 determines whether all the valid data of the transcription source block is completely transcribed (S136). In a case where the transcription is not completed (No in S136), the procedure returns to the process of S134. On the other hand, in a case where the transcription is completed (Yes in S136), the block size reduction processing unit 107 registers the storing position (the physical address) at the transcription destination corresponding to the logical address of the transcribed valid data in the address translation table 101A to update the mapping (S137). Therefore, all the valid data in the transcription source block becomes the invalid data. Subsequently, the block size reduction processing unit 107 registers the transcription source block, which has been completely transcribed with data, in the first free block management information 102C (S138), and registers the transcription destination block, in which valid data is newly stored, in the MLC block management information 102G (S139). Thereafter, the block size reduction processing unit 107 performs the process of S131 again.

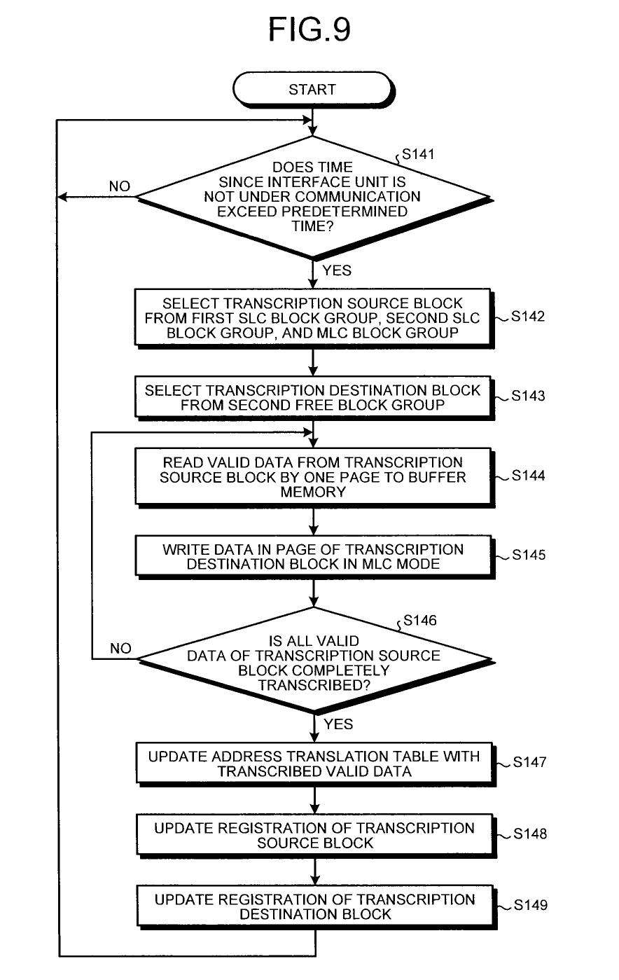

FIG. 9 is a flowchart for describing the second transcription process.

The block size reduction processing unit 107 monitors the interface unit 130 to determine whether the interface unit 130 is not under operation in excess of a predetermined time (S141). In a case where the interface unit 130 is not under operation within the predetermined time (No in S141), the block size reduction processing unit 107 performs the process of S141 again.

In a case where the interface unit 130 is not under operation in excess of the predetermined time (Yes in S141), the block size reduction processing unit 107 selects the transcription source block from the first SLC block group, the second SLC block group, or the MLC block group (S142). Herein, the block size reduction processing unit 107 may select the transcription source block from any one of the first SLC block group, the second SLC block group, and the MLC block group. For example, the block size reduction processing unit 107 may select a block having the smallest amount of the valid data or the earliest-written block as the transcription source block among the blocks classified into the first SLC block group, the second SLC block group, and the MLC block group. In addition, the block size reduction processing unit 107 may preferentially select the second SLC block and the MLC block as the transcription destination block among the second SLC block, the MLC block, and the first SLC block. In addition, the block size reduction processing unit 107 may preferentially select the second SLC block as the transcription destination block from the second SLC block and the MLC block. Further, the block size reduction processing unit 107 may select a plurality of transcription source blocks in the process of S142.

Next, the block size reduction processing unit 107 selects the transcription destination block from the second free block group (S143). In a case where a plurality of transcription source blocks are selected in the process of S142, the transcription destination blocks are selected as many as a total amount of the valid blocks stored in the plurality of transcription source blocks.

Next, the block size reduction processing unit 107 secures the data storage area as much as at least one page on the buffer memory unit 120, and subsequently reads the valid data as much as one page stored in the selected M transcription source blocks and sends out the valid data to the data storage area secured in the buffer memory unit 120 (S144). Then, the block size reduction processing unit 107 writes the valid data, which is read and sent out onto the buffer memory unit 120, in a page of a free block selected as the transcription destination block in the MLC mode (S145).

Next, the block size reduction processing unit 107 determines whether all the valid data of the transcription source block is completely transcribed (S146). In a case where the transcription is not completed (No in S146), the procedure returns to the process of S144. On the other hand, in a case where the transcription is completed (Yes in S146), the block size reduction processing unit 107 registers the storing position (the physical address) at the transcription destination corresponding to the logical address of the transcribed valid data in the address translation table 101A to update the mapping (S147).

Next, the block size reduction processing unit 107 registers the transcription source block, which has been completely transcribed with data, in the first free block management information 102C or the second free block management information 102E (S148), and registers the transcription destination block, in which valid data is newly stored, in the MLC block management information 102G (S149). Thereafter, the block size reduction processing unit 107 performs the process of S141 again.

Further, in a case where an N-bit value is stored in one cell in the MLC mode, the block size of the MLC block becomes N times the block size of the first SLC block and the second SLC block. Therefore, the total capacity of the nonvolatile memory unit 110 is determined according to the setting of the threshold Tc. Regarding the threshold Tc, it is assumed that all Tc blocks among the blocks belonging to the second block group are written in the SLC mode and the other blocks among the blocks belonging to the second block group are not written in the SLC mode. In this case, the threshold Tc may be set to make the total capacity of the nonvolatile memory unit 110 larger than the expressed capacity (Condition 1).

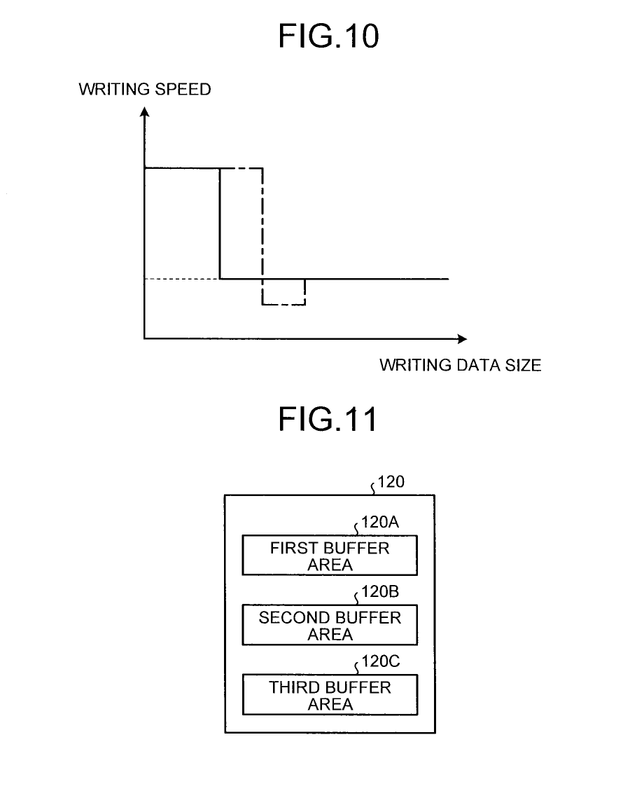

FIG. 10 is a diagram illustrating a change in writing performance in a case where the host device 150 makes a request for writing data continuously to the memory system 1 in a shipping state. In FIG. 10, the vertical axis represents a writing speed, and the horizontal axis represents a written data size. In addition, the solid line represents a performance in a case where the threshold Tc (Tc1) is set to satisfy Condition 1, the chain line represents a performance in a case where the threshold Tc (Tc2) is set not to satisfy Condition 1. Tc1 is smaller than Tc2. The writing speed in the MLC mode is slower than that in the SLC mode. Therefore, in a case where Tc1 is set to the threshold Tc, the blocks to be written in the SLC mode run out earlier than a case where Tc2 is set to the threshold Tc. Then, the writing speed is reduced from a writing speed in the SLC mode to a writing speed in the MLC mode at timing when the blocks to be written in the SLC mode run out. On the contrary, in a case where Tc2 is set to the threshold Tc, the writing speed in the SLC mode can be maintained longer than a case where Tc1 is set to the threshold Tc. However, there is a need to transcribe the valid data, which is written in the first SLC block, in the MLC mode to prevent the writable capacity from reaching the expressed capacity. Since the transcription consumes the resources of the controller 100, the writing performance is reduced during the transcription compared to the writing speed in the MLC mode. Therefore, in a case where the date writing is performed continuously to the memory system 1 in a shipping state, undershoot occurs in the writing speed as plotted by the chain line. In other words, in a case where the threshold Tc is set to satisfy Condition 1 and thus the data writing is continuously requested, the occurrence of the undershoot in the writing speed can be suppressed.

As described above, according to the first embodiment, the memory system 1 is provided with the nonvolatile memory unit 110 and the controller 100. The nonvolatile memory unit 110 is provided with a plurality of first blocks in which data is written in the first mode, and a plurality of second blocks in which data is written in the first mode or the second mode. The plurality of first blocks are provided with the first free block in which no valid data is stored. The plurality of second blocks are provided with the second free block in which no valid data is stored. In a case where the number of the first free blocks is larger than the threshold Ta, the controller 100 writes the data requested for writing from the host device 150 in the first free block. In a case where the number of the first free blocks is smaller than the threshold Ta, the controller writes the data in the second free block. In a case where the number of the first free blocks is large, the writing is performed in the SLC mode of a high writing speed. When the number of the first free blocks becomes small, the writing is performed on the second free block in which the writing is possible in either the SLC mode or the MLC mode. Therefore, an increase in writing speed and an increase in available writing capacity are realized.

In addition, in a case where the number of the second free blocks is smaller than the threshold Tb, the controller 100 writes the data requested for writing from the host device 150 in the second free block in the second mode. In a case where the number of the second free blocks becomes small, the writing is performed in a mode having a large storage capacity per volume. Therefore, it is possible to prevent that the available writing capacity runs out even when the writing is advanced.

In addition, in a case where the number of the second SLC blocks is larger than the threshold Tc, the controller 100 writes the data requested for writing from the host device 150 in the second free block in the second mode. In a case where the number of the second SLC blocks is large, the writing is performed in a mode having a large storage capacity per volume. Therefore, it is possible to prevent that the available writing capacity runs out even when the writing is advanced.

In addition, in a case where the number of the first free block is smaller than the threshold Td which is larger than the threshold Ta, the controller 100 performs the first transcription process. The first transcription process selects at least one of the first SLC blocks, transcribes the valid data stored in the selected first SLC block to the second free block in the second mode, and invalidates the valid data stored in the selected first SLC block. Therefore, it is possible to prevent that the available writing capacity runs out even when the writing is advanced.

Further, in the first transcription process, the controller 100 may be configured to transcribe the target valid data to the second free block in the first mode.

In addition, in a case where the elapsed time exceeds a predetermined time as a result of measuring the elapsed time since the interface unit 130 is not under communication, the controller 100 starts the second transcription process. The second transcription process is a process in which at least one of the first SLC block, the second SLC block, and the MLC block is selected, the valid data stored in the selected block is transcribed to the second free block, and the valid data stored in the selected block is invalidated. Therefore, in a case where the free blocks run short as the writing is advanced, the free blocks can be generated.

Further, the controller 100 may write the valid data which is the transcription target in the first free block. In addition, since the valid data stored in the first SLC block becomes a transcription target by the first transcription process, the first SLC block may not be selected as the transcription source block in the second transcription process.

Further, in a case where a sum of the number of the second free blocks and the number of the first free blocks, the number of the second free blocks, and the number of the first free blocks is smaller than a threshold Te and the elapsed time since the interface unit 130 is not under communication exceeds a predetermined time, the controller 100 may start the second transcription process.

### Second Embodiment

In a second embodiment, the memory system 1 can determine whether the data requested for writing is written in the first block group or in the second block group according to information (additional information) which is added to a writing request from the host device 150. In addition, the memory system 1 can determine whether the data is written in the SLC mode or in the MLC mode in the second block group according to the additional information. Further, the additional information, for example, may be a parameter according to an update frequency. The parameter according to the update frequency, for example, may be set according to data sections (data disposed in a txt area, data disposed in a stack area, data disposed in a heap area, and data disposed in a data area) as disclosed in Publication of Japanese Unexamined Patent Application No. 2012-33002. In addition, the memory system 1 may write data requested for writing according to the additional information indicating a “High” update frequency in the first block group, and data requested for writing according to the additional information indicating a “Low” update frequency in the second block group. In addition, when writing data in the second block group, the memory system 1 may write data in the SLC mode according to the additional information indicating the “High” update frequency, and data in the MLC mode according to the additional information indicating the “Low” update frequency.

The configuration of the memory system 1 according to the second embodiment will be described. In the second embodiment, the memory system 1 is configured to secure memory areas in the buffer memory unit 120 for every block group (the first SLC block group, the second SLC block group, and the MLC block group) in order to switch a writing destination according to the additional information. FIG. 11 is a diagram illustrating a memory configuration of the buffer memory unit 120 according to the second embodiment. As illustrated in the drawing, the buffer memory unit 120 is configured to secure a first memory area 120A, a second memory area 120B, and a third memory area 120C. The first memory area 120A is accumulated with the data which is written in the first free block in the SLC mode. The second memory area 120B is accumulated with the data which is written in the second free block in the SLC mode. The third memory area 120C is accumulated with the data which is written in the second free block in the MLC mode.

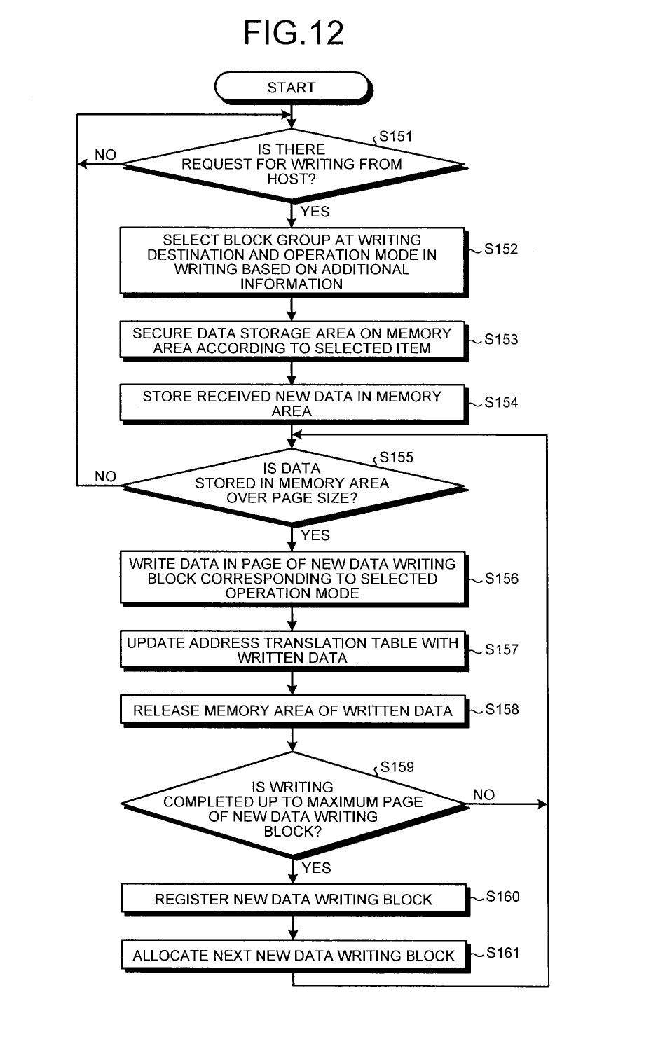

FIG. 12 is a flowchart illustrating the operation when the host device 150 makes a request for writing data. Further, in the operation illustrated in FIG. 12, it is assumed that a new data writing block has been allocated individually to every memory area (the first memory area 120A, the second memory area 120B, and the third memory area 120C) as an initial state.

The write command processing unit 105, first, waits for the input of a write command for new data from the host device 150 to the interface unit 130 (No in S151). When the write command is received (Yes in S151), the write command processing unit 105 selects a block group at a writing destination and an operation mode at the time of writing based on the additional information of the write command (S152). Herein, the write command processing unit 105 can select any one of the first SLC block group and the second SLC block group as a block group at the writing destination based on the additional information. In a case where the first SLC block group is selected, the write command processing unit 105 selects the SLC mode as the operation mode at the time of writing. In a case where the second SLC block group is selected, the write command processing unit 105 can select one of the SLC mode and the MLC mode as the operation mode at the time of writing based on the additional information.

Next, the write command processing unit 105 secures the data storage area on the memory area according to the items (options) selected in S152 (S153). Then, new data transmitted from the host device 150 is stored in the data storage area which has been secured in the memory area (S154). Further, the data size of unwritten new data which has been stored in the memory area is checked (S155). In a case where the data size is less than a page size (No in S155), the write command processing unit 105 performs the process of S151 again. On the other hand, in a case where the data size is equal to or larger than the page size (Yes in S155), the write command processing unit 105 selects data as much as the page size from the unwritten data in the memory area and writes the selected data in a page of the new data writing block corresponding to the options in the selected operation mode (S156).

Subsequently, the write command processing unit 105 registers the logical address and the storing position (the physical address) of the written data in the address translation table 101A (S157) to update the mapping. Then, the write command processing unit 105 releases the memory area in which the written data is stored (S158).

Next, the write command processing unit 105 determines whether there is a page having no written data, that is, an unwritten page in the new data writing block (S159). In a case where there is an unwritten page in the new data writing block (No in S159), the write command processing unit 105 performs the process of S155 again.

On the other hand, in a case where there is no unwritten page (Yes in S159), that is, when the data writing is completed up to a last page in the new data writing block, the write command processing unit 105 performs a registration process of registering the new data writing block in management information which is selected according to the options among the first SLC block management information 102D, the second SLC block management information 102F, and the MLC block management information 102G (S160).

Next, the write command processing unit 105 performs the allocation process for the next new data writing block (S161). In the allocation process of S161, the write command processing unit 105 allocates the new data writing block to every block group (the first SLC block group, the second SLC block group, and the MLC block group) to be registered. After the process of S161, the write command processing unit 105 performs the process of S151 again.

In this way, according to the second embodiment, the memory system 1 can receive a writing request according to the additional information. The controller 100 writes the data requested for writing from the host device 150 in a block of the first block group or the second block group according to the additional information. Therefore, the host device 150 can perform management such that data having a high update frequency is written in the first block group in the SLC mode, and data having a low update frequency is written in the second block group in the SLC mode or the MLC mode.

In addition, when data requested for writing from the host device 150 is written in the second block group, the controller 100 may write the data in the operation mode which corresponds to one of the SLC mode and the MLC mode according to the additional information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a nonvolatile memory formed of a plurality of memory cells, and configured to include a plurality of first blocks in which data is written in a first mode and a plurality of second blocks in which data is written in the first mode or a second mode, the second mode being a mode such that each memory cell has a larger storage capacity than that of the first mode; and
a controller, wherein
the plurality of first blocks include a third block in which no valid data is stored,
the plurality of second blocks include a fourth block in which no valid data stored, and
the controller writes data requested for writing from a host in the third block when the number of the third blocks is larger than a first threshold and in the fourth block when the number of the third blocks is smaller than the first threshold.

2. The memory system according to claim 1, wherein
the controller writes data requested for writing from the host in the fourth block in the second mode when the number of the fourth blocks is smaller than a second threshold.

3. The memory system according to claim 1, wherein
the plurality of second blocks include a fifth block in which data written in the first mode is stored, and
the controller writes data requested for writing from the host in the fourth block in the second mode when the number of the fifth blocks is larger than a third threshold.

4. The memory system according to claim 1, wherein
the plurality of first blocks include a sixth block in which data written in the first mode is stored,
the controller performs a first transcription process when the number of the third blocks is smaller than a fourth threshold which is larger than the first threshold, and
the first transcription process is a process in which at least one of the sixth blocks is selected, valid data stored in the selected sixth block is transcribed to the fourth block, and the valid data stored in the selected sixth block is invalidated.

5. The memory system according to claim 4, wherein
the controller writes the valid data stored in the selected sixth block in the fourth block in the second mode when the valid data stored in the selected sixth block is transcribed.

6. The memory system according to claim 1, further comprising
an interface unit configured to communicate with the host, wherein
the controller measures an elapsed time since the interface unit is not under communication, and starts a second transcription process when the elapsed time exceeds a predetermined time, and
the second transcription process is a process in which at least one of the fifth block and the sixth block is selected, valid data stored in the selected block is transcribed to the third block or the fourth block, and the valid data stored in the selected block is invalidated.

7. The memory system according to claim 6, wherein
the controller starts the second transcription process when the number of the third blocks, the number of the fourth blocks, or a sum of the number of the third blocks and the number of the fourth blocks is smaller than a fifth threshold.

8. The memory system according to claim 3, wherein
the third threshold is set in advance such that a total capacity of the memory when the number of the fifth blocks is equal to the third threshold becomes larger than a capacity expressed to the host.

9. A memory system comprising:
a nonvolatile memory configured to include a plurality of first blocks in which data is written in a first mode and a plurality of second blocks in which data is written in the first mode or a second mode having a larger storage capacity per unit volume than that of the first mode;
a controller; and
an interface unit configured to receive a writing request from a host, wherein
the writing request includes additional information,
the plurality of first blocks include a third block in which no valid data is stored,
the plurality of second blocks include a fourth block in which no valid data is stored, and
the controller writes the data requested for writing from a host in one of the third block and the fourth block according to the additional information.

10. The memory system according to claim 9, wherein
when the data requested for writing from the host is written in the fourth block, the controller writes the data in one of the first mode and the second mode according to the additional information.

11. A method of causing a controller to control a nonvolatile memory which includes a plurality of blocks, the plurality of blocks including a plurality of first blocks in which data is written in a first mode and a plurality of second blocks in which data is written in the first mode or a second mode, the second mode being a mode such that each memory cell has a larger storage capacity than that of the first mode, the method comprising:
receiving, by the controller, a request for writing data from a host;
performing, by the controller, a first comparison process in which the number of third blocks having no stored valid data among the plurality of first blocks is compared to a first threshold; and
performing, by the controller, a first writing process in which when the number of the third blocks is larger than the first threshold, the data requested for writing from the host is written in the third block, and when the number of the third blocks is smaller than the first threshold, the data requested for writing from the host is written in a fourth block in which no valid data is stored among the plurality of second blocks.

12. The method according to claim 11, wherein
the first writing process includes
a second comparison process in which the number of the fourth blocks is compared to a second threshold, and
a second writing process in which when the number of the fourth blocks is smaller than a second threshold, the data requested for writing from the host is written in the fourth block in the second mode.

13. The method according to claim 11, wherein
the plurality of second blocks include a fifth block in which data written in the first mode is stored, and
the first writing process includes
a third comparison process in which the number of the fifth blocks is compared to a third threshold, and
a third writing process in which when the number of the fifth blocks is larger than a third threshold, the data requested for writing from the host is written in the fourth block in the second mode.

14. The method according to claim 11, wherein
the plurality of first blocks include a sixth block in which data written in the first mode is stored,
the method further comprising:
performing, by the controller, a fourth comparison process in which the number of the third blocks is compared to a fourth threshold which is larger than the first threshold; and
when the number of the third blocks is smaller than the fourth threshold, performing, by the controller, a first transcription process in which at least one of the sixth blocks is selected, valid data stored in the selected sixth block is transcribed to the fourth block, and the valid data stored in the selected sixth block is invalidated.

15. The method according to claim 14, wherein
the first transcription process includes
a third writing process in which when the valid data stored in the selected sixth block is transcribed, the valid data stored in the selected sixth block is written in the fourth block in the second mode.

16. The method according to claim 11, further comprising:
performing, by the controller, a fifth comparison process in which an elapsed time since communication with the host is disconnected is measured and the elapsed time is compared to a predetermined time; and
when the elapsed time exceeds the predetermined time, performing, by the controller, a second transcription process in which the controller selects at least one of the fifth block and the sixth block, transcribes the valid data stored in the selected block to the third block or the fourth block, and invalidates the valid data stored in the selected block.

17. The method according to claim 16, further comprising
performing, by the controller, a sixth comparison process in which the number of the third blocks, the number of the fourth blocks, or a sum of the number of the third blocks and the number of the fourth blocks is compared to a fifth threshold; and wherein
when the sum is smaller than the fifth threshold, performing, by the controller, the second transcription process.

18. The method according to claim 13, wherein
the third threshold is set in advance such that a total capacity of the memory when the number of the fifth blocks is equal to the third threshold becomes larger than an advertised capacity provided to the host.

19. A method of causing a controller to control a nonvolatile memory which includes a plurality of blocks, the plurality of blocks including a plurality of first blocks in which data is written in a first mode and a plurality of second blocks in which data is written in the first mode or a second mode, the second mode being a mode such that each memory cell has a larger storage capacity than that of the first mode, the method comprising:
receiving, by the controller, a request for writing data along with additional information from a host;
selecting, by the controller, one of a third block having no stored valid data among the plurality of first blocks and a fourth block having no stored valid data among the plurality of second blocks according to the additional information; and
performing, by the controller, a first writing process in which data requested for writing from the host is written in the selected block.

20. The method according to claim 19, wherein
the first writing process includes
a process in which one of the first mode and the second mode is selected according to the additional information, and
a process in which the data requested for writing from the host is written in the selected block in the selected mode.
